(19) United States
(12) Patent Application Publication
(10) Pub. No.: US 2025/0187911 A1
(43) Pub. Date: Jun. 12, 2025

(54) METHODS OF TRANSPORTING HYDROGEN

(71) Applicant: Saudi Arabian Oil Company, Dhahran (SA)

(72) Inventors: Guanghui Zhu, Dhahran (SA); Raed H. Abudawoud, Dhahran (SA); Faisal M. Almulla, Dhahran (SA); Anas S. Al-Aqeeli, Dhahran (SA)

(73) Assignee: Saudi Arabian Oil Company, Dhahran (SA)

(21) Appl. No.: 18/535,446

(22) Filed: Dec. 11, 2023

(51) Int. Cl. C01B 3/00

(52) U.S. Cl. CPC C01B 3/0015; C01B 2203/065; C01B 2203/1247; C01B 2203/1252; C01B 2203/148

(57) ABSTRACT

A method of transporting hydrogen may comprise providing hydrogen gas comprising a first hydrogen gas portion produced by a method with no direct carbon emissions to the atmosphere and a second hydrogen gas portion produced by a method with direct carbon emissions to the atmosphere; at a first hydrocarbon processing facility, hydrogenating a hydrocarbon feed in the presence of the hydrogen gas to form a hydrogenated effluent; transporting a portion of the hydrogenated effluent from the first hydrocarbon processing facility to a second hydrocarbon processing facility; and at the second hydrocarbon processing facility, dehydrogenating the portion of the hydrogenated effluent to form a hydrogen gas product. On average, a mass flow rate of the first hydrogen gas portion may be at least 90% of a mass flow rate of the hydrogen gas product. The first hydrocarbon processing facility and the second hydrocarbon processing facility may be separated by a distance of at least 100 km.

### TECHNICAL FIELD

Embodiments of the present disclosure generally relate to hydrogen processing, and more specifically, to methods and systems utilized in the transportation of hydrogen.

### BACKGROUND

Hydrogen is growing in importance as an environmentally friendly precursor chemical and fuel. Processes for the production and usage of hydrogen are relatively well developed. However, processes for the storage and transportation of hydrogen are still insufficient to meet the needs of the hydrogen industry. Generally, hydrogen is stored and transported in the form of compressed gaseous hydrogen molecules (e.g., at above 5,000 pounds per square inch). However, these conventional gaseous hydrogen transportation techniques are costly and inefficient. For example, the compression process consumes a large amount of energy (estimated to be 30% or more of the energy content of the hydrogen). Also, transport and storage of the compressed hydrogen requires expensive pressure vessels. Some of the hydrogen molecules can even escape through the walls of hydrogen containment vessels. The hydrogen can also cause embrittlement of the storage and transport vessels. Overall, better methods of hydrogen storage and transport are needed.

### BRIEF SUMMARY

Generally, hydrogen gas may be produced by methods with direct carbon emissions into the atmosphere or methods without direct carbon emissions into the atmosphere. Hydrogen produced by methods with direct carbon emissions is not generally considered environmentally friendly due to the release of carbon dioxide in its production. On the other hand, hydrogen produced by methods without direct carbon emissions is sometimes more valuable in the market. However, such hydrogen is often not available in sufficient quantities, particularly in certain geographic regions of the world where hydrogen gas sourcing is important for price.

Moreover, hydrogen gas is extremely costly and difficult to transport over large distances. One method whereby hydrogen gas may be transported utilizes hydrogenating hydrocarbons to form a product that is more easily transported than hydrogen gas, transporting these hydrogenated hydrocarbons, and then dehydrogenating these hydrocarbons to form hydrogen gas at a second location.

Described herein are methods whereby hydrogen gas may be transported by hydrogenation and dehydrogenation of hydrocarbons at different locations, and where the product hydrogen gas may be marketed as hydrogen produced by methods that do not directly emit carbon to the atmosphere. In the embodiments described herein, a hydrocarbon feed may be hydrogenated to “capture” hydrogen atoms. As only a portion of the hydrogenated hydrocarbons may have hydrogen atoms recoverable by later dehydrogenation, this portion may be transported to a second hydrocarbon processing facility. For example, a portion of the hydrogenated hydrocarbons having recoverable hydrogen atoms may include cyclo-hexane moieties that may be converted to aromatic moieties during dehydrogenation, releasing product hydrogen gas. By the methods disclosed, the approximate amount of hydrogen gas that is produced by the dehydrogenation reaction may be inputted to the hydrogenation reaction as hydrogen gas that is sourced from methods that do not emit carbon. In particular, some hydrogen gas that is formed by methods that emit carbon, and some hydrogen gas that is formed by methods that do not emit carbon, are utilized in the hydrogenation reaction in amounts that allow for the product hydrogen at the second hydrocarbon processing facility to be marketable as “clean” hydrogen, made by sources that do not directly emit carbon.

According to one or more embodiments, a method of transporting hydrogen may comprise: providing hydrogen gas comprising a first hydrogen gas portion and a second hydrogen gas portion; at a first hydrocarbon processing facility, hydrogenating a hydrocarbon feed in a hydrogenator, in the presence of the hydrogen gas comprising the first hydrogen gas portion and the second hydrogen gas portion, to form a hydrogenated effluent that comprises hydrogen atoms from the first hydrogen gas portion and the second hydrogen gas portion; transporting a portion of the hydrogenated effluent from the first hydrocarbon processing facility to a second hydrocarbon processing facility; and at the second hydrocarbon processing facility, dehydrogenating the portion of the hydrogenated effluent to form a hydrogen gas product and a separated-dehydrogenated effluent. The first hydrogen gas portion may be hydrogen produced by a method with no direct carbon emissions to the atmosphere and the second hydrogen gas portion may be hydrogen produced by a method with direct carbon emissions to the atmosphere. The first hydrocarbon processing facility and the second hydrocarbon processing facility may be separated by a distance of at least 100 km. On average, a mass flow rate of the first hydrogen gas portion may be at least 90% of a mass flow rate of the hydrogen gas product. The hydrogenated effluent may have a greater ratio of hydrogen to carbon than the hydrocarbon feed.

These and other embodiments are described in more detail in the Detailed Description. It is to be understood that both the foregoing general description and the following detailed description present embodiments of the presently disclosed technology, and are intended to provide an overview or framework for understanding the nature and character of the technology as it is claimed. The accompanying drawings are included to provide a further understanding of the presently disclosed technology and are incorporated into and constitute a part of this specification. The drawings illustrate various embodiments and, together with the description, serve to explain the principles and operations of the presently disclosed technology. Additionally, the drawings and descriptions are meant to be merely illustrative, and are not intended to limit the scope of the claims in any manner.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1 schematically depicts a diagram of a system for transporting hydrogen, according to one or more embodiments described in this disclosure;

FIG. 2 schematically depicts a diagram of another system for transporting hydrogen, according to one or more embodiments described in this disclosure;

FIG. 3 schematically depicts a diagram of yet another system for transporting hydrogen, according to one or more embodiments described in this disclosure; and

FIG. 4 schematically depicts a diagram of yet another system for transporting hydrogen, according to one or more embodiments described in this disclosure.

For the purpose of describing the simplified schematic illustrations and descriptions of the relevant figures, the numerous valves, temperature sensors, electronic controllers and the like that may be employed and well known to those of ordinary skill in the art of certain chemical processing operations are not included. Further, accompanying components that are often included in typical chemical processing operations, such as air supplies, catalyst hoppers, and flue gas handling systems, are not depicted. However, operational components, such as those described in the present disclosure, may be added to the embodiments described in this disclosure.

It should further be noted that arrows in the drawings refer to process streams. However, the arrows may equivalently refer to transfer lines which may serve to transfer process streams between two or more system components. Additionally, arrows that connect to system components define inlets or outlets in each given system component. The arrow direction corresponds generally with the major direction of movement of the materials of the stream contained within the physical transfer line signified by the arrow. Furthermore, arrows which do not connect two or more system components signify a product stream which exits the depicted system or a system inlet stream which enters the depicted system. Product streams may be further processed in accompanying chemical processing systems or may be commercialized as end products. System inlet streams may be streams transferred from accompanying chemical processing systems or may be non-processed feedstock streams. Some arrows may represent recycle streams, which are effluent streams of system components that are recycled back into the system. However, it should be understood that any represented recycle stream, in some embodiments, may be replaced by a system inlet stream of the same material, and that a portion of a recycle stream may exit the system as a system product.

Additionally, arrows in the drawings may schematically depict process steps of transporting a stream from one system component to another system component. For example, an arrow from one system component pointing to another system component may represent “passing” a system component effluent to another system component, which may include the contents of a process stream “exiting” or being “removed” from one system component and “introducing” the contents of that product stream to another system component. It should be understood that arrows in the relevant figures are not indicative of necessary or essential steps.

It should be understood that according to the embodiments presented in the relevant figures, an arrow between two system components may signify that the stream is not processed between the two system components. In other embodiments, the stream signified by the arrow may have substantially the same composition throughout its transport between the two system components. Additionally, it should be understood that in one or more embodiments, an arrow may represent that at least 75 wt. %, at least 90 wt. %, at least 95 wt. %, at least 99 wt. %, at least 99.9 wt. %, or even 100 wt. % of the stream is transported between the system components. As such, in some embodiments, less than all of the streams signified by an arrow may be transported between the system components, such as if a slip stream is present.

It should be understood that two or more process streams are “mixed” or “combined” when two or more lines intersect in the schematic flow diagrams of the relevant figures. Mixing or combining may also include mixing by directly introducing both streams into a like reactor, separation device, or other system component. For example, it should be understood that when two streams are depicted as being combined directly prior to entering a separation unit or reactor, that in some embodiments the streams could equivalently be introduced into the separation unit or reactor and be mixed in the reactor.

Reference will now be made in greater detail to various embodiments, some embodiments of which are illustrated in the accompanying drawings. Whenever possible, the same reference numerals will be used throughout the drawings to refer to the same or similar parts.

### DETAILED DESCRIPTION

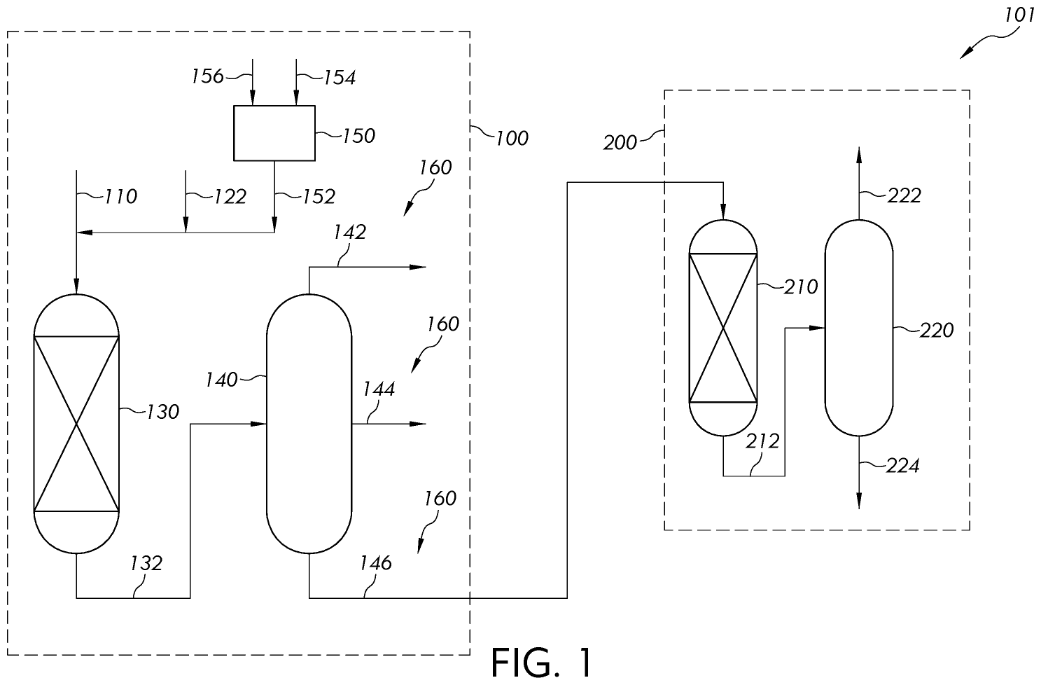

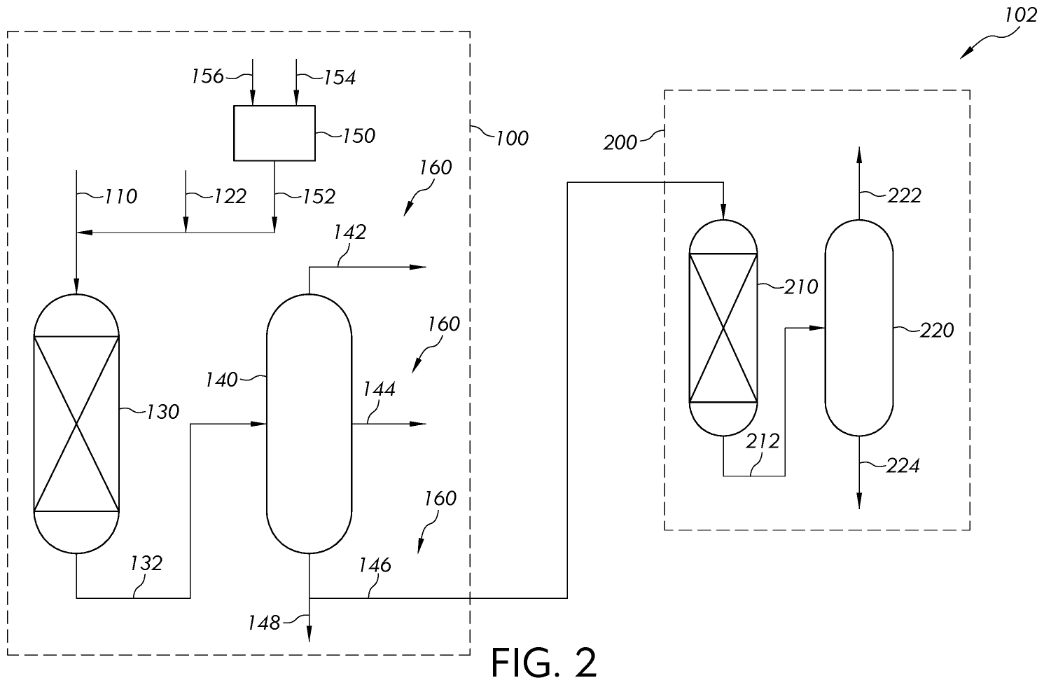

One or more embodiments of the present disclosure relate to methods for transporting hydrogen from one geographic region to another. In general, these methods are described herein in the context of one or more systems, shown in the drawings. The embodiments of FIGS. 1-4 are similar or identical in many ways, respectively, but include differences as described herein. Description of the embodiments of FIGS. 1-4 may generally apply to the embodiments of the other figures, as would be understood by those skilled in the art. For example, concepts disclosed herein applicable to FIG. 1 may be equally applicable to FIG. 2, and vice versa, even if not explicitly stated as such herein.

As described herein, a “hydrogenator” generally refers to a unit designed to perform a hydrogenation reaction on a hydrocarbon feed. A hydrogenation reaction refers to any reaction of hydrogen with an organic compounds. The hydrogenation reaction may occur either as direct addition of hydrogen to the double bonds of unsaturated molecules, resulting in an at least partially saturated product, or the hydrogenation reaction may cause the rupture of bonds of organic compounds, with subsequent reaction of hydrogen with the molecular fragments. Examples of the first type of hydrogenation (also referred to as addition hydrogenation) include the conversion of aromatics to cycloparaffins. Examples of the second type include hydrocracking. The hydrogenator may be located within a hydrocarbon processing facility, such as an oil refinery. Suitable hydrogenators include, but are not limited to, hydrotreaters and hydrocrackers.

As described herein, a “hydrotreater” generally refers to a unit that may be within a refinery and designed to perform the hydrotreating process on a hydrocarbon feed. The hydrotreating process generally refers to the process of contacting a hydrocarbon feed with hydrogen and a hydrotreating catalyst at elevated temperature to remove or convert at least a portion of one or more impurities, such as sulfur, nitrogen, metals, and/or olefins. As described herein, a “naphtha hydrotreater” generally refers to a unit within a refinery designed to perform the hydrotreating process on naphtha fractions, such as heavy naphtha.

As used in this disclosure, “cracking” refers to a chemical reaction where a molecule having carbon-carbon bonds is broken into more than one molecule by the breaking of one or more of the carbon-carbon bonds; where a compound including a cyclic moiety, such as an aromatic, is converted to a compound that does not include a cyclic moiety; or where a molecule having carbon-carbon double bonds are reduced to carbon-carbon single bonds. Some catalysts may have multiple forms of catalytic activity, and calling a catalyst by one particular function does not render that catalyst incapable of being catalytically active for other functionality. In general, “hydrocracking” refers to cracking in the presence of hydrogen. As described herein, a “hydrocracker” generally refers to a unit that may be within a refinery and designed to perform the hydrocracking process on a hydrocarbon feed.

As used in this disclosure, a “catalyst” refers to any substance which increases the rate of a specific chemical reaction. Catalysts described in this disclosure may be utilized to promote various reactions, such as, but not limited to, hydrogenation and dehydrogenation reactions. As used in this disclosure, a “hydrogenation catalyst” increases the rate of a hydrogenation reaction. As used in this disclosure, a “dehydrogenation catalyst” increases the rate of a dehydrogenation reaction. The methods described herein should not necessarily be limited by specific catalytic materials unless explicitly stated as such.

As used in this disclosure, a “separation unit” refers to any separation device or system of separation devices that at least partially separates one or more chemicals that are mixed in a process stream from one another. For example, a separation unit may selectively separate differing chemical species, phases, or sized material from one another, forming one or more chemical fractions. Examples of separation units include, without limitation, distillation columns, flash drums, knock-out drums, knock-out pots, centrifuges, cyclones, filtration devices, traps, scrubbers, expansion devices, membranes, solvent extraction devices, and the like. It should be understood that separation processes described in this disclosure may not completely separate all of one chemical constituent from all of another chemical constituent. It should be understood that the separation processes described in this disclosure “at least partially” separate different chemical components from one another, and that even if not explicitly stated, it should be understood that separation may include only partial separation.

Referring now to FIG. 1, where a system for transporting hydrogen 101 is depicted. The system for transporting hydrogen 101 may include at least a first hydrocarbon processing facility 100 and a second hydrocarbon processing facility 200, where the first hydrocarbon processing facility 100 and the second hydrocarbon processing facility 200 are in different geographic locations, as described herein. In general, a single hydrocarbon processing facility, such as the first hydrocarbon processing facility 100 and a second hydrocarbon processing facility 200, may be a processing facility that is only locally integrated with other processing facilities, and generally refers to an integrated complex capable of transforming its respective hydrocarbon feedstock into its respective products. For example, a single hydrocarbon processing facility may be under the control of a single entity, such as a company. In embodiments, each of the first hydrocarbon processing facility 100 and the second hydrocarbon processing facility 200 may independently be oil refineries. For example, the first hydrocarbon processing facility 100 and a second hydrocarbon processing facility 200 may be oil refineries or chemical processing facilities, respectively, that are in different geographic regions, such as different states, countries, counties, provinces, continents, etc.

The first hydrocarbon processing facility 100 and the second hydrocarbon processing facility 200 may be separate from one another and in different geographic regions. For example, the first hydrocarbon processing facility 100 and the second hydrocarbon processing facility 200 may be at least 100 km apart from one another, such as at least 200 km apart from one another, at least 500 km apart from one another, or at least 1000 km apart from one another.

The physical distance between the first hydrocarbon processing facility 100 and the second hydrocarbon processing facility 200 may make conventional transportation of hydrogen between the first hydrocarbon processing facility 100 and the second hydrocarbon processing facility 200 difficult and/or costly. Use of the present methods and systems may allow cheaper and more efficient transport of hydrogen between the first hydrocarbon processing facility 100 and the second hydrocarbon processing facility 200, thereby allowing an operator to take advantage of cheaper and/or renewable sources of electricity available near the first hydrocarbon processing facility 100 to form hydrogen. In some embodiments, the first hydrocarbon processing facility 100 and the second hydrocarbon processing facility 200 may be located at different latitudes, which may allow the operator to take advantage of variations in energy production, such as the increased production of electricity of a given solar panel when placed closer to the equator.

As shown in FIG. 1, the first hydrocarbon processing facility 100 may comprise a hydrogenator 130 and a separation unit 140, and the second hydrocarbon processing facility 200 may comprise a dehydrogenation unit 210 and a liquid-gas separation unit 220. These system components and their various arrangements will be described in detail herein.

Still referring to FIG. 1, the first hydrogen gas feed 152, a second hydrogen gas feed 122, and a hydrocarbon feed 110 may be passed to hydrogenator 130 to form hydrogenated effluent 132. In some embodiments, as described herein, the first hydrogen gas feed 152 may comprise a first hydrogen gas portion produced by a method with no direct carbon emissions to the atmosphere and the second hydrogen gas feed 122 may comprise a second hydrogen gas portion produced by a method with direct carbon emissions to the atmosphere. Direct carbon emissions generally refers to carbon, such as in the form of carbon dioxide, that is emitted to the environment (i.e., not sequestered) in a process that produces hydrogen, such as from the release of carbon dioxide from fossil fuels during hydrogen production. Although not depicted in the figure, excess hydrogen gas from the hydrogenator 130 is separated from the hydrogenated effluent 132 and passed back to the hydrogenator 130. Thus, the hydrogen gas from the first hydrogen gas portion and the second hydrogen gas portion provide makeup hydrogen to replace hydrogen consumed in the hydrogenation reactions.

Hydrogen may be produced by a wide variety of methods and resources. Based on environmental sustainability, some hydrogen may be more valuable based on its origin and production means. For example, hydrogen that is produced with little or no carbon emission may be more valuable in the marketplace. These include the first, second, and third hydrogen production methods described herein below, which produce hydrogen with no direct carbon emissions, as well as hydrogen that is naturally occurring (sometimes referred to as “white hydrogen” in industry).

A first hydrogen generation technique includes a water electrolysis process by employing renewable electricity (sometimes referred to as “green hydrogen” in industry). Generally, there is no carbon dioxide emissions during this production technique. Renewable electricity may be generated from, without limitation, wind, solar, geothermal, hydroelectric, marine, biomass, and other forms of electricity produced from renewable resources that do not contribute to carbon emissions.

As depicted in FIG. 1, the first hydrogen portion may be produced by water electrolysis. However, as described herein, other methods of producing the first hydrogen portion that do not form direct carbon emissions are also contemplated. According to one or more embodiments, at the first hydrocarbon processing facility 100, water 154 may be passed to an electrolysis cell 150, where a source of electricity 156 is used to produce a first hydrogen gas feed 152 comprising a first hydrogen gas portion. The electrolysis cell 150 may produce the first hydrogen gas portion from water and electricity through the process of electrolysis. Generally, the electrolysis of water refers to the decomposition of water into oxygen gas and hydrogen gas by passing an electric current through the water. Generally, electrochemical cells configured for the production of hydrogen have two electrodes, a cathode and an anode. The electrodes are immersed in the water and externally connected with a power supply. At a critical voltage, hydrogen and oxygen are produced. The reactions proceed as follows:

2H⁺ (aq)+2e⁻→H₂ (g) (1)

4OH⁻ (aq)→2H₂O+O₂ (g)+4e⁻ (2)

The electrolysis cell 150 may be characterized by the chemistry of the electrolyte. For example, the electrolysis cell 150 may be an alkaline electrolysis cell comprising a porous separator and an alkaline electrolyte or a proton exchange membrane (“PEM”) electrolysis cell comprising an acidic membrane separator which also functions as an acidic electrolyte, or a solid oxide electrolysis cell comprising a solid oxide electrolyte (e.g., yttrium-stabilized-zirconia). The anodes and the cathodes may be unipolar or bipolar. When the electrodes are unipolar, each electrode functions as a terminal electrode. Bipolar electrolyzers may include many cells operating in series. Each electrode in the bipolar electrolyzer, with the exception of the two terminal electrodes, may function as a cathode on one side of the electrode and an anode at the other side of the electrode.

The electrolysis cell 150 may be operated at a temperature in the range from 10° C. to 99° C., such as from 10° C. to 20° C., from 20° C. to 30° C., from 30° C. to 40° C., from 40° C. to 50° C., from 50° C. to 60° C., from 60° C. to 70° C., from 70° C. to 80° C., from 80° C. to 90° C., from 90° C. to 99° C., or any combination of these ranges. In embodiments, the electrolysis cell 150 may be an alkaline or PEM electrolysis cell and the operating temperature may be in the range from 10° C. to 99° C. In embodiments, the electrolysis cell 150 may be a solid oxide electrolysis cell operated at a temperature in the range from 500° C. to 900° C. The electrolysis cell 150 may be operated at a hydrogen pressure of from 1 bar to 500 bar, such as from 1 bar to 10 bar, from 10 bar to 50 bar, from 50 bar to 100 bar, from 100 bar to 200 bar, from 200 bar to 300 bar, from 300 bar to 400 bar, from 400 bar to 500 bar, or any combination of these ranges.

The source of electricity 156 to the electrolysis cell 150 may be electricity produced from energy provided by a non-hydrocarbon source. Generally, the use of electricity produced from energy provided by a non-hydrocarbon source means that first hydrogen gas portion produced in the electrolysis cell 150 may be referred to as “green” hydrogen and may thus be more valuable than other types of hydrogen. Suitable sources of electricity 156 may include, by way of example but not limitation, solar energy, wind energy, hydroelectric energy, geothermal energy, tidal energy, or a combination thereof.

A second hydrogen generation technique includes producing hydrogen by utilization of fossil fuels, but all of the generated carbon dioxide is captured and sequestered, such as sequestered underground (sometimes referred to as “gray hydrogen” in industry). Since no carbon is emitted into the atmosphere, this is considered carbon neutral in industry.

A third hydrogen generation technique includes extracting energy from nuclear reactions, where in general carbon dioxide is not emitted. Several techniques are known for forming hydrogen from nuclear fission and/or fusion, including hydrogen that is made though using nuclear power and heat through combined chemo thermal electrolysis splitting of water (sometimes referred to as “purple hydrogen” in industry); hydrogen that is generated through electrolysis of water by using electricity from a nuclear power plant (also sometimes referred to as “purple hydrogen” in industry); and hydrogen that is produced through the high-temperature catalytic splitting of water using nuclear power thermal as an energy source (sometimes referred to as “red hydrogen” in industry).

The second hydrogen gas portion may comprise hydrogen produced by a method with direct emissions to the atmosphere, such as from a hydrocarbon source in the absence of carbon sequestration. These include, without limitation, hydrogen is produced from fossil fuel and commonly uses steam methane reforming (SMR) method (sometimes referred to as “gray hydrogen” in industry), hydrogen is produced from coal, usually by gasification (sometimes referred to as “black hydrogen” or “brown hydrogen” in industry). This hydrogen produced by a method with direct emissions to the atmosphere may be less valuable than other types of hydrogen and/or more readily available, especially at hydrocarbon processing facilities, such as oil refineries, where hydrogen produced by a method with direct emissions to the atmosphere may be a byproduct chemical already in production. Producing hydrogen from a hydrocarbon source may refer to converting the hydrocarbons to hydrogen and carbon dioxide (although other compounds such as carbon monoxide may also be generated). For example, hydrogen may be produced from a hydrocarbon source through partial oxidation gasification process and subsequent water-gas shift reactions. Generally, a partial oxidation gasification process converts hydrocarbons into a gaseous mixture often referred to as syngas (i.e., a mixture of carbon monoxide and hydrogen). The carbon monoxide is then combined with high temperature steam to convert the carbon monoxide in the syngas to hydrogen and carbon dioxide. However, other common refinery processes such as catalytic reforming also produce hydrogen gas from hydrocarbons, this hydrogen gas may form a part of the second hydrogen gas portion.

In some embodiments, a ratio of the number of hydrogen atoms in the first hydrogen gas portion to the number of hydrogen atoms in the second hydrogen gas portion may be from 9:1 to 1:9. Generally, on a per-mol basis, hydrogen in the first hydrogen gas portion may be more expensive and/or less readily available than hydrogen in the second portion and thus it may be desirable to minimize the amount of hydrogen from the first hydrogen gas portion which is utilized. However, it may also be desirable to include sufficient hydrogen from the first portion such that all hydrogen produced in the hydrogen gas product can be attributed to the first hydrogen gas portion, as described in more detail herein. Typically, the amount of hydrogen gas passed to the hydrogenator 130 is greater than the amount of hydrogen gas consumed by the hydrogenation reactions. The excess hydrogen gas is typically separated from the hydrogenated effluent 132 and recycled back to the hydrogenator 130. The hydrogen gas recycled back to the hydrogenator 130 may enter the hydrogenator through second hydrogen gas feed 122 or through a separate hydrogen gas inlet. Hydrogen gas recycled back to the hydrogenator 130 does not count as part of the first hydrogen gas portion or the second hydrogen gas portion. In some embodiments, the ratio of the number of hydrogen atoms in the first hydrogen gas portion to the number of hydrogen atoms in the second hydrogen gas portion may be from 9:1 to 7:1. From 7:1 to 5:1, from 5:1 to 3:1, from 3:1 to 1:1, from 1:1 to 1:3, from 1:3 to 1:5, from 1:5 to 1:7, from 1:7 to 1:9, or any combination of one or more of these ranges.

In some embodiments, the hydrocarbon feed 110 passed to the hydrogenator 130 may comprise hydrocarbons. The hydrocarbon feed 110 may comprise any hydrocarbon feed capable of being hydrogenated and which produces a hydrogenated effluent capable of being dehydrogenated.

In embodiments, the hydrocarbon feed 110 may comprise hydrocarbons. The hydrocarbons may include a crude oil cut, aromatic compounds, a refinery stream, or combinations of these. In embodiments, the hydrocarbon feed 110 may have an initial boiling point of from 80° C. to 100° C., such as from 80° C. to 85° C., from 85° C. to 90° C., from 90° C. to 95° C., from 95° C. to 100° C., from 88° C. to 92° C., or any combination of these ranges. In embodiments, the hydrocarbon feed 110 may have a final boiling point of from 180° C. to 450° C., such as from 180° C. to 200° C., from 200° C. to 220° C., from 220° C. to 250° C., from 250° C. to 300° C., from 300° C. to 350° C., from 350° C. to 400° C., from 400° C. to 450° C. or any combination of these ranges.

In some embodiments, the hydrocarbon feed 110 may comprise a crude oil or a portion thereof, such as a cut of a crude oil, such as heavy naphtha. In embodiments, the crude oil cut may have an initial boiling point (“IBP”) of from 80° C. to 100° C., such as from 80° C. to 85° C., from 85° C. to 90° C., from 90° C. to 95° C., from 95° C. to 100° C., from 88° C. to 92° C., or any combination of these ranges. The crude oil cut may have a final boiling point (“FBP”) of from 180° C. to 220° C., such as from 180° C. to 190° C., from 190° C. to 200° C., from 200° C. to 210° C., from 210° C. to 220° C., from 195° C. to 205° C., or any combination of these ranges.

In embodiments, the hydrocarbon feed 110 may comprise aromatic compounds (e.g., compounds comprising aromatic moieties). The hydrocarbon feed 110 may comprise C9+ aromatic compounds (i.e., aromatic compounds having at least 9 carbon atoms). Suitable C9+ aromatic compounds may include, without limitation, benzyl toluene, dibenzyl toluene, methylindole, phenazine, diphenyl methane, and ethylcarbazole. In embodiments, the hydrocarbon feed 110 may comprise at least 25 wt. %, such as at least 35 wt. %, at least 50 wt. %, at least 60 wt. %, at least 70 wt. %, at least 80 wt. %, at least 90 wt. %, at least 95 wt. %, at least 99 wt. %, or even at least 99.9 wt. % of aromatic compounds (e.g., C9+ aromatic compounds), on the basis of the total weight of hydrocarbon feed 110.

In embodiments, the hydrocarbon feed 110 may comprise a mixture of a crude oil cut, such as heavy naphtha, with C9+ aromatic compounds. In embodiments, the hydrocarbon feed 110 comprising the mixture of the crude oil cut and the C9+ aromatic compounds may comprise from 5 volume percent (vol. %) to 90 vol. % of the C9+ aromatic compounds, on the basis of the total volume of the hydrocarbon feed 110. In embodiments, the hydrocarbon feed 110 comprising the mixture of the crude oil cut and the C9+ aromatic compounds may comprise from 5 vol. % to 10 vol. %, from 10 vol. % to 20 vol. %, from 20 vol. % to 40 vol. %, from 40 vol. % to 60 vol. %, from 60 vol. % to 80 vol. %, from 80 vol. % to 100 vol. %, or any combination of one or more of these ranges of the C9+ aromatic compounds, on the basis of the total volume of the hydrocarbon feed 110.

Still referring to FIG. 1, according to methods described herein, hydrogen may be transported from the first hydrocarbon processing facility 100 to the second hydrocarbon processing facility 200 by transporting hydrogenated hydrocarbons between the hydrocarbon processing facilities. In embodiments, the hydrocarbon feed 110, second hydrogen gas feed 122 comprising the second hydrogen gas portion, and first hydrogen gas feed 152 comprising the first hydrogen gas portion may be passed to the hydrogenator 130 to form hydrogenated effluent 132. The hydrogenator 130 may hydrogenate the hydrocarbon feed 110 by contacting the hydrocarbon feed 110 with hydrogen from the first hydrogen gas portion and the second hydrogen gas portion and a hydrogenation catalyst.

In embodiments, the hydrogenator 130 may be a hydrotreater or a hydrocracker, such as a hydrotreater or a hydrocracker in an oil refinery. In the hydrogenator 130, at least a portion of the hydrocarbons in the hydrocarbon feed 110 may be hydrogenated. For example, when aromatic moieties are present in the hydrocarbon feed 110, at least a portion of the aromatic moieties may be converted to cyclohexane moieties. For example, when olefin moieties are present in the hydrocarbon feed 110, at least a portion of the olefin moieties may be converted to alkane moieties. In some embodiments, the hydrogenator may crack hydrocarbons in the presence of hydrogen. For example, the hydrogenator 130 may break carbon-carbon bonds and hydrogenate the cracked products. It is contemplated that the hydrogenation of the hydrocarbons in the hydrocarbon feed 110 compounds may be by thermal hydrogenation, at the temperatures experienced in the hydrogenator 130, or the reaction may be catalytically enhanced by the hydrogenation catalyst. It is contemplated that the hydrogenation of the hydrocarbons may take place at the same conditions as is normally utilized for naphtha hydrotreating or for naphtha hydrocracking.

The hydrogenator 130 may include a hydrogenation catalyst, where the hydrocarbons and other chemicals present in the hydrogenator 130 may be contacted with the hydrogenation catalyst in the presence of hydrogen. Contemplated hydrogenation catalysts may include combinations of metals including Co, Ni, Mo and W. Contemplated combinations of metals include cobalt-molybdenum (Co—Mo), nickel-molybdenum (Ni—Mo), nickel-tungsten (Ni—W), nickel-molybdenum-tungsten (Ni—Mo—W), and/or noble metal catalysts. In embodiments, the catalyst may be supported, such as on an alumina support, a silica support, or a silica-alumina support (e.g., a zeolite support). The hydrogenator 130 may be operated at a reaction temperature from 50° C. to 700° C., such as from 50° C. to 100° C., from 100° C. to 200° C., from 200° C. to 300° C., from 300° C. to 400° C., from 400° C. to 500° C., from 500° C. to 600° C., from 600 to 700° C. or any combination of these ranges. The hydrogenator 130 may be operated at a pressure of from 10 bar to 300 bar, such as from 10 bar to 250 bar, from 10 bar to 200 bar, from 10 bar to 150 bar, from 15 bar to 300 bar, from 15 bar to 200 bar, from 15 bar to 150 bar, or any subset thereof. The hydrogenator 130 may be operated at a liquid hourly space velocity (“LHSV”) of from 0.5 h⁻¹ to 5 h⁻¹, such as from 0.5 h⁻¹ to 1 h⁻¹, from 1 h⁻¹ to 2 h⁻¹, from 2 h⁻¹ to 3 h⁻¹, from 3 h⁻¹ to h⁻¹, from 4 h⁻¹ to 5 h⁻¹, or any combination of these ranges.

In some embodiments, the hydrogenator 130 may produce the hydrogenated effluent 132 which may comprise the hydrogenation products of the hydrocarbon feed 110. The hydrogenated effluent 132 may have a greater ratio of hydrogen to carbon than the hydrocarbon feed 110 that was subjected to hydrogenation in the hydrogenator 130. In embodiments, the hydrogenated effluent 132 may comprise saturated hydrocarbons (e.g., hydrocarbons having no carbon-carbon double bonds). In embodiments, at least 60 wt. %, at least 70 wt. %, at least 80 wt. %, at least 90 wt. %, at least 95 wt. %, or even at least 99 wt. % of the hydrocarbons in the hydrogenated effluent 132 may be saturated hydrocarbons, on the basis of the total weight of the hydrogenated effluent 132. Thus, hydrogen atoms from the hydrogen gas in the first hydrogen gas portion and the second hydrogen gas portion are incorporated into the hydrocarbons in the hydrogenated effluent 132, facilitating the transport of hydrogen between the hydrocarbon processing facilities.

In some embodiments, the hydrogenated effluent 132 may have been hydrotreated in the hydrogenator 130. Thus, the hydrogenated effluent 132 may have a lesser concentration of sulfur and/or nitrogen than hydrocarbon feed 110. For example, the hydrogenated effluent 132 may have less than 25 wt. %, less than 10 wt. %, less than 1 wt. %, less than 0.1 wt. %, or even less than 0.01 wt. % of the combined weight of sulfur and nitrogen of the hydrocarbon feed 110. In embodiments, the hydrogenated effluent 132 may have a total sulfur and nitrogen content of less than 250 ppm, less than 100 ppm, less than 50 ppm, less than 25 ppm, less than 10 ppm, or less than 5 ppm, by weight.

Still referring to FIG. 1, in some embodiments, the hydrogenated effluent 132 may be passed to separation unit 140 to form one or more hydrogenated hydrocarbon cuts 160. In embodiments, the hydrogenated effluent 132 may be passed to the separation unit 140 to form a first hydrogenated hydrocarbon cut 146, a second hydrogenated hydrocarbon cut 144, and a third hydrogenated hydrocarbon cut 142. The separation unit 140 may be any suitable separation unit, such as, and without limitation, an extractive separation unit that separates feedstock based on chemical affinity, a series of flash vessels or a fractionator/distillation column that separates feedstock based on the boiling point, or both.

In some embodiments, the first hydrogenated hydrocarbon cut 146 may comprise hydrocarbons, such as saturated hydrocarbons. In some embodiments, the first hydrogenated hydrocarbon cut 146 may comprise saturated cyclic C9+ hydrocarbon. In some embodiments, the first hydrogenated hydrocarbon cut 146 may have an initial boiling point (IBP) of from 80° C. to 160° C., such as from 80° C. to 100° C., from 100° C. to 120° C., from 120° C. to 140° C., from 140° C. to 160° C., or any combination of these ranges. The first hydrogenated hydrocarbon cut 146 may have a final boiling point (FBP) of from 180° C. to 450° C., such as from 180° C. to 200° C., from 200° C. to 225° C., from 225° C. to 250° C., from 250° C. to 300° C., from 300° C. to 350° C., from 350° C. to 400° C., from 400° C. to 450° C., or any combination of these ranges. Generally, this first hydrogenated hydrocarbon cut 146 may be liquid, or easier to liquefy than hydrogen, and thus easier to transport than hydrogen gas. Thus, hydrogen may be transported over vast distances, such as between countries or continents, without the need for new process equipment or costly hydrogen gas pressurization. In embodiments, at least 60 wt. %, at least 70 wt. %, at least 80 wt. %, at least 90 wt. %, at least 95 wt. %, or even at least 99 wt. % of the hydrocarbons in the first hydrogenated hydrocarbon cut 146 may be saturated hydrocarbons, (e.g., hydrocarbons having no carbon-carbon double bonds), on the basis of the total weight of the first hydrogenated hydrocarbon cut 146. In some embodiments, the first hydrogenated hydrocarbon cut 146 may be liquid at ambient temperature and pressure (e.g., 20° C. and 1 atmosphere).

In some embodiments, the second hydrogenated hydrocarbon cut 144 may comprise hydrocarbons initially in the hydrogenated effluent 132 and boiling at a lesser boiling temperature than the first hydrogenated hydrocarbon cut 146. In some embodiments, the third hydrogenated hydrocarbon cut 142 may comprise hydrocarbons initially in the hydrogenated effluent 132 and hydrocarbons boiling at a lesser boiling temperature than second hydrogenated hydrocarbon cut 144. In some embodiments, the second hydrogenated hydrocarbon cut 144 and the third hydrogenated hydrocarbon cut 142 may comprise hydrogen, and C₂-C₄ hydrocarbons.

Still referring to FIG. 1, at least a portion of the hydrogenated effluent 132, such as at least one of the hydrogenated hydrocarbon cuts 160 may be transported from the first hydrocarbon processing facility 100 to the second hydrocarbon processing facility 200. In some embodiments, the first hydrogenated hydrocarbon cut 146 may be transported from the first hydrocarbon processing facility 100 to the second hydrocarbon processing facility 200. In some embodiments not shown in the figures, the hydrogenated effluent 132, or a portion thereof which has not been separated by boiling point, may be transported from the first hydrocarbon processing facility 100 to the second hydrocarbon processing facility).

Transporting may refer to the process of physically moving hydrocarbons, and to the process of preparing the hydrocarbons to be physically moved, from the first hydrocarbon processing facility 100 to the second hydrocarbon processing facility 200, and to the storage of hydrocarbons before, during, or after physical movement of the hydrocarbons. Where hydrogen is transported, the hydrogen may be transported in the form of hydrogen atoms covalently bonded to hydrocarbon molecules. In embodiments, transporting the hydrogenated effluent 132, or a portion thereof, may comprise transporting the hydrogenated effluent 132 from the first hydrocarbon processing facility 100 to the second hydrocarbon processing facility 200 by tanker truck, train, ship, pipeline, or the like. In embodiments, transporting the at least one hydrogenated hydrocarbon cut 160 (e.g., the first hydrogenated hydrocarbon cut 146) may comprise transporting the at least one hydrogenated hydrocarbon cut 160 from the first hydrocarbon processing facility 100 to the second hydrocarbon processing facility 200 by tanker truck, train, ship, pipeline, or the like. In embodiments, the hydrocarbons may be transported from the first hydrocarbon processing facility 100 to the second hydrocarbon processing facility 200 by tanker truck, train, and/or ship. A time of at least 2 weeks, such as at least 1 month, at least 2 months, or at least 6 months, may pass between hydrogenating the hydrocarbon feed 110 and dehydrogenating the hydrocarbons (e.g., the at least one hydrogenated hydrocarbon cut 160). The transportation step may include storing the hydrocarbons at the first hydrocarbon processing facility 100, the second hydrocarbon processing facility 200, at an intermediate storage or processing facility, or in the transportation vessel itself. The temporal difference between the hydrogenating and dehydrogenating steps may allow the operator to store intermittent electricity in the form of hydrogen for use during times of higher demand, such as storing summer solar power for winter.

At the second hydrocarbon processing facility 200, at least a portion of the hydrogenated effluent 132, such as the hydrogenated hydrocarbon cut 160, which was transported to the second hydrocarbon processing facility 200 may be passed to a dehydrogenation unit 210 to form dehydrogenated effluent 212, which includes entrained hydrogen gas. In some embodiments, the at least a portion of the hydrogenated effluent 132 which is passed to the dehydrogenation unit 210 may not have been separated by boiling point. In other embodiments, the at least a portion of the hydrogenated effluent 132 which is passed to the dehydrogenation unit 210 may have been separated by boiling point to form the hydrogenated hydrocarbon cut 160.

The dehydrogenation unit 210 may be any process unit capable of removing hydrogen atoms from a hydrogen molecule to form hydrogen gas. Suitable process units for use as dehydrogenation unit 210 include, for example, propane dehydrogenation units, butane dehydrogenation units, steam crackers, catalytic reformers, aromatization units, and the like. The dehydrogenation unit 210 may include a catalyst, where the hydrocarbons and other chemicals in the dehydrogenation unit 210 may be contacted with the catalyst to dehydrogenate the hydrocarbons and release hydrogen gas. Contemplated catalysts may comprise iron (e.g., iron (III) oxide), potassium oxide, potassium chloride, noble metal (e.g., Pt or Re). Contemplated catalysts include those supported on a silica base, an alumina base, a silica-alumina base, or a combination thereof. The dehydrogenation unit 210 may operate at a reaction temperature of from of from 50° C. to 700° C., such as from 50° C. to 100° C., from 100° C. to 200° C., from 200° C. to 300° C., from 300° C. to 400° C., from 400° C. to 500° C., from 500° C. to 600° C., from 400° C. to 600° C., or any combination of these ranges; a reaction pressure of from 1 bar to 50 bar, such as from 1 bar to 5 bar, from 5 bar to 10 bar, from 10 bar to 20 bar, from 20 bar to 30 bar, from 30 bar to 40 bar, from 40 bar to 50 bar, or any combination of these ranges; and a liquid hourly space velocity (“LHSV”) of from 0.5 h⁻¹ to 5 h⁻¹, such as from 0.5 h⁻¹ to 1 h⁻¹, from 1 h⁻¹ to 2 h⁻¹, from 2 h⁻¹ to 3 h⁻¹, from 3 h⁻¹ to 4 h⁻¹, from 4 h⁻¹ to 5 h⁻¹, or any combination of these ranges.

The dehydrogenation unit 210 may produce a dehydrogenated effluent 212 that may comprise hydrocarbons (e.g., the dehydrogenation reaction products of the first hydrogenated hydrocarbon cut 146) and entrained hydrogen gas. The hydrocarbons of dehydrogenated effluent 212 may have a lower hydrogen to carbon ratio than first hydrogenated hydrocarbon cut 146. For example, the dehydrogenated effluent 212 may have a lower degree of saturation (e.g., having more carbon-carbon double bonds) than first hydrogenated hydrocarbon cut 146. In embodiments, dehydrogenated effluent 212 may comprise at least 50 wt. %, at least 60 wt. %, at least 70 wt. %, at least 80 wt. %, at least 90 wt. %, at least 95 wt. %, or at least 99 wt. % of aromatic compounds, such as C9+ aromatic compounds, on the basis of the total hydrocarbon weight of dehydrogenated effluent 212. Without being limited by theory, it is believed that when the dehydrogenation reaction produces aromatic compounds, the hydrogen produced may be purer (e.g., having lower concentrations of carbon monoxide) than when the dehydrogenation reaction produces non-aromatic compounds. This purity is believed to be due to decreased cracking of the hydrocarbon feeds and decreased CO formation when the end product is an aromatic compound.

Still referring to FIG. 1, the dehydrogenated effluent 212 may be passed to liquid-gas separation unit 220, to form separated-dehydrogenated effluent 224 and hydrogen gas, at least a portion of which may be included in hydrogen gas product 222. The liquid-gas separation unit 220 may be any suitable liquid-gas separation unit, such as a flash drum, breakpot, knock-out drum, compressor suction drum, suction scrubber, vent scrubber, or demister.

The hydrogen gas product 222 may comprise hydrogen gas. In embodiments, the hydrogen gas product 222 may comprise at least 80 mol. %, at least 90 mol. %, at least 95 mol. %, at least 99 mol. %, at least 99.9 mol. %, at least 99.99 mol. %, at least 99.999 mol. %, or even at least 99.9999 mol. % hydrogen, on the basis of the total number of moles of gas in the hydrogen gas product 222. The hydrogen gas product 222 may comprise less than 500 parts per million by weight (ppm), less than 250 ppm, less than 100 ppm, less than 50 ppm, less than 20 ppm, or less than 10 ppm, less than 5 ppm, less than 2.5 ppm, or less than 1 ppm of each of sulfur and carbon monoxide. One practical and growing application for hydrogen gas is for use in fuel cells. Generally, low temperature fuel cells use precious metal catalysts which are susceptible to poisoning by sulfur and CO in their hydrogen fuels. Thus, it may be desirable for the hydrogen gas product 222 to contain relatively low amounts of sulfur and CO.

In order to produce hydrogen produced by methods without direct carbon emissions at the second hydrocarbon processing facility 200, sufficient hydrogen from the first hydrogen gas portion may be supplied to the hydrogenator 130, such that the most or all of the hydrogen released into the hydrogen gas product 222 can be attributed to the first hydrogen gas portion. Attributing hydrogen to the first hydrogen gas portion means that, on an overall mass balance, it is possible that the hydrogen atoms present in the hydrogen gas product 222 could have been supplied by the first hydrogen gas portion. Attributing hydrogen to the first hydrogen gas portion does not require tracking individual hydrogen atoms through their respective flows and chemical bonds, but rather that the number of hydrogen atoms released could have been provided by the first hydrogen gas portion, based on the amounts of the first hydrogen gas portion supplied and the amounts of the hydrogen gas product 222 produced. In embodiments, on average, a mass flow rate of the first hydrogen gas portion may be at least 90%, such as at least 95%, at least 99%, at least 100%, at least 105%, or at least 110% of a mass flow rate of the hydrogen gas product 222. Due to the delays in transportation and storage of the hydrogenated effluent 132, the system for transporting hydrogen 101 may only approach steady state over a relatively long period of time, such as months or years. Thus, the average mass flow rates should be calculated over a time period of at least 6 months, at least 1 year, at least 2 years, at least 3 years, or at least 5 years. For example, if over a time period of at least 6 months (such as at least 1 year, at least 2 years, at least 3 years, or at least 5 years) the 1000 kg of hydrogen were released into the hydrogen gas product 222, at least 900 kg (such as at least 950 kg, at least 990 kg, at least 1000 kg, at least 1050 kg, or at least 1100 kg) of hydrogen would be supplied to the hydrogenator 130 by the first hydrogen portion.

In some embodiments, the amount of hydrogen supplied to the hydrogenator 130 by the first hydrogen gas portion may be greater than the number of hydrogen atoms which may bond to the hydrocarbon feed 110, or to the portions of the hydrocarbon feed 110 intended to carry hydrogen atoms from the first hydrocarbon processing facility 100 to the second hydrocarbon processing facility 200 (e.g., the first hydrogenated hydrocarbon cut 146). In some embodiments, the number of hydrogen atoms supplied to the hydrogenator 130 by the first hydrogen gas portion may be greater than the number of hydrogen atoms which may bond to the C9+ aromatic compounds in the hydrocarbon feed 110. In some embodiments, the weight ratio of hydrogen atoms from the first hydrogen portion to the C9+ aromatic compounds in the hydrocarbon feed 110 may be at least 1:14, such as at least 1:13, at least 1:12, at least 1:10, at least 1:8, at least 1:6, from 1:14 to 1:4, from 1:14 to 1:12, from 1:12 to 1:10, from 1:10 to 1:8, from 1:8 to 1:6, from 1:6 to 1:4, or any combination of one or more of these ranges.

The separated-dehydrogenated effluent 224 may comprise the hydrocarbons originally in dehydrogenated effluent 212. In embodiments, the separated-dehydrogenated effluent 224 may comprise at least 50 wt. %, at least 60 wt. %, at least 70 wt. %, at least 80 wt. %, at least 90 wt. %, at least 95 wt. %, or at least 99 wt. % of C9+ aromatic hydrocarbons (e.g., benzyl toluene) on the basis of the total weight of separated-dehydrogenated effluent 224. Although not shown in the figure, the separated-dehydrogenated effluent 224 may be transported back to the first hydrocarbon processing facility 100 for use a part of the hydrocarbon feed 110, the separated-dehydrogenated effluent 224 may be discharged away from the second hydrocarbon processing facility 200, or the separated-dehydrogenated effluent 224 may be converted to a product at the second hydrocarbon processing facility 200.

Referring now to FIG. 2, another system for transporting hydrogen 102 is depicted. The system for transporting hydrogen 102 may be similar or identical to the system for transporting hydrogen 101 of FIG. 1, except where described otherwise. In particular, in the system for transporting hydrogen 102, only a portion of first hydrogenated hydrocarbon cut 146 may be transported from the first hydrocarbon processing facility 100 to the second hydrocarbon processing facility 200. The remainder of first hydrogenated hydrocarbon cut 146 may form separated hydrogenated hydrocarbon cut 148 and may be converted at the first hydrocarbon processing facility 100 or may be discharged out of first hydrocarbon processing facility 100 to another facility. Generally, when insufficient hydrogen is supplied to the hydrogenator 130 by the first hydrogen portion, it may be preferable not to send the entirety of the first hydrogenated hydrocarbon cut 146 to the second hydrocarbon processing facility 200, such that the entirety of the hydrogen gas product 222 can be attributed to the first hydrogen gas portion.

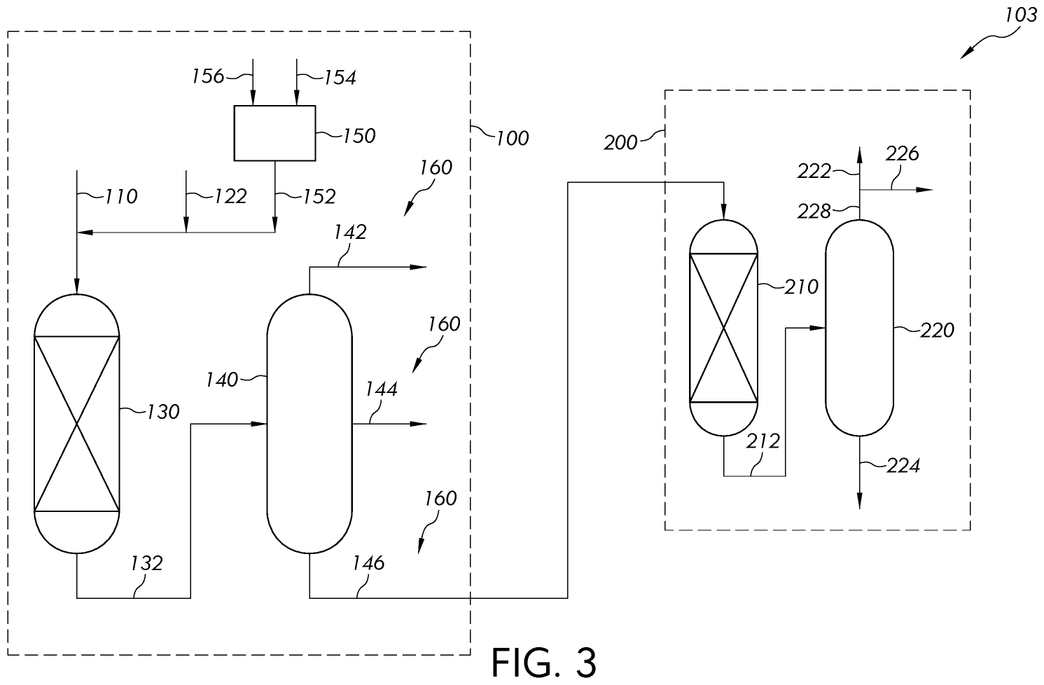

Referring now to FIG. 3, another system for transporting hydrogen 103 is depicted. The system for transporting hydrogen 103 may be similar or identical to the system for transporting hydrogen 101 of FIG. 1, except where described otherwise. In particular, in the system for transporting hydrogen 103, the liquid-gas separation unit 220 may produce a combined hydrogen gas product 228. The combined hydrogen gas product 228 may then be further separated into a conventional hydrogen gas product 226 and the hydrogen gas product 222. In such embodiments, the amount of hydrogen atoms in the hydrogen gas product 222 may represent the hydrogen atoms from the first hydrogen gas portion. Generally, when insufficient hydrogen is supplied to the hydrogenator 130 by the first hydrogen portion, it may be preferable not consider the entirety of the hydrogen gas released at the second hydrocarbon processing facility 200 as being part of the hydrogen gas product 222, such that the entirety of the hydrogen gas product 222 can be attributed to the first hydrogen gas portion.

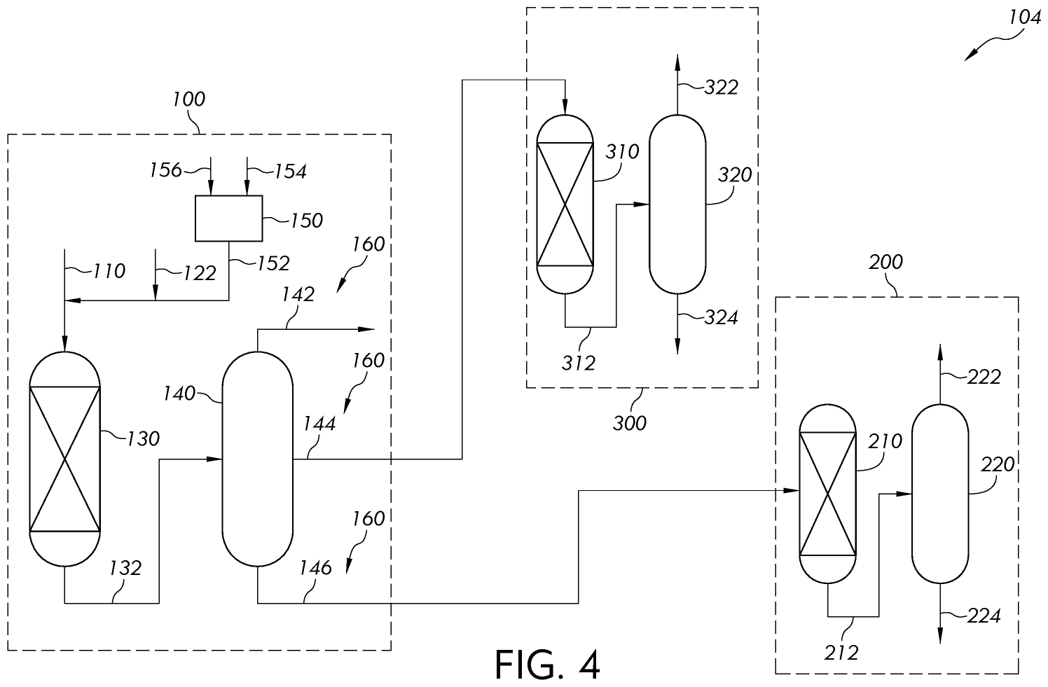

Referring now to FIG. 4, another system for transporting hydrogen 104 is depicted. The system for transporting hydrogen 104 may be similar or identical to the system for transporting hydrogen 101 of FIG. 1, except where described otherwise. In particular, in the system for transporting hydrogen 104, the treatment of the hydrogenated hydrocarbon cuts 160 may be different from their treatment in system for transporting hydrogen 101. For example, in the system for transporting hydrogen 104, the second hydrogenated hydrocarbon cut 144 may be transported to a third hydrocarbon processing facility 300. At the third hydrocarbon processing facility 300, the second hydrogenated hydrocarbon cut 144 may be passed to dehydrogenation unit 310 to form dehydrogenated effluent 312, which may be subsequently passed to liquid-gas separation unit 320 to form hydrogen gas product 322 and separated-dehydrogenated effluent 324.

The third hydrocarbon processing facility 300 may comprise any new or conventional hydrocarbon processing facility capable of dehydrogenating one or more hydrogenated hydrocarbon cuts 160 (e.g., the second hydrogenated hydrocarbon cut 144). For example, the third hydrocarbon processing facility 300 may be an oil refinery or a chemical processing plant. The third hydrocarbon processing facility may be at least 100 km, such as at least 200 km, at least 500 km, or at least 100 km from the first hydrocarbon processing facility 100. The third hydrocarbon processing facility 300 may comprise any of the dehydrogenation units discussed herein in reference to the second hydrocarbon processing facility 200 (e.g., a steam cracker, an aromatization unit, or a catalytic reformer). The dehydrogenation unit 310 may be substantially similar to dehydrogenation unit 210. The dehydrogenated effluent 312 may be substantially similar to dehydrogenated effluent 212. The liquid-gas separation unit 320 may be substantially similar to liquid-gas separation unit 220. The separated-dehydrogenated effluent 324 may be substantially similar to separated-dehydrogenated effluent 224. The hydrogen gas product 322 may be substantially similar to hydrogen gas product 222.

In order to produce hydrogen produced by methods without direct carbon emissions hydrogen at both the second hydrocarbon processing facility 200 and the third hydrocarbon processing facility 300, sufficient hydrogen from the first hydrogen gas portion may be supplied to the hydrogenator 130, such that the most or all of the hydrogen released into the hydrogen gas product 222 and the hydrogen gas product 322 can be attributed to the first hydrogen gas portion. In embodiments, on average, a mass flow rate of the first hydrogen gas portion may be at least 90%, such as at least 95%, at least 99%, at least 100%, at least 105%, or at least 110%, from 90% to 200%, from 90% to 150%, from 90% to 115%, from 90% to 100%, from 100% to 115%, from 115% to 130%, from 130% to 150%, 150% to 175%, from 175% to 200%, or any subset of these ranges, of a combined mass flow rate of the hydrogen gas product 222 and hydrogen gas product 322.

Numerous aspects are included in the present disclosure, including aspects 1-20.

Aspect 1. A method of transporting hydrogen, the method comprising: providing hydrogen gas comprising a first hydrogen gas portion and a second hydrogen gas portion, wherein the first hydrogen gas portion is hydrogen produced by a method with no direct carbon emissions to the atmosphere and the second hydrogen gas portion is hydrogen produced by a method with direct carbon emissions to the atmosphere; at a first hydrocarbon processing facility, hydrogenating a hydrocarbon feed in a hydrogenator, in the presence of the hydrogen gas comprising the first hydrogen gas portion and the second hydrogen gas portion, to form a hydrogenated effluent that comprises hydrogen atoms from the first hydrogen gas portion and the second hydrogen gas portion, wherein the hydrogenated effluent has a greater ratio of hydrogen to carbon than the hydrocarbon feed; transporting a portion of the hydrogenated effluent from the first hydrocarbon processing facility to a second hydrocarbon processing facility, wherein the first hydrocarbon processing facility and the second hydrocarbon processing facility are separated by a distance of at least 100 km; and at the second hydrocarbon processing facility, dehydrogenating the portion of the hydrogenated effluent to form a hydrogen gas product and a separated-dehydrogenated effluent; wherein, on average, a mass flow rate of the first hydrogen gas portion is at least 90% of a mass flow rate of the hydrogen gas product.

Aspect 2. The method of aspect 1, further comprising, at the first hydrocarbon processing facility, separating the hydrogenated effluent into two or more hydrogenated hydrocarbon cuts, wherein the portion of the hydrogenated effluent that is transported to the second hydrocarbon processing facility comprises one of the two or more hydrogenated hydrocarbon cuts.

Aspect 3. The method of aspect 2, further comprising: transporting at least one of the two or more hydrogenated hydrocarbon cuts to a third hydrocarbon processing facility; and at the third hydrocarbon processing facility, dehydrogenating the at least one hydrogenated hydrocarbon cut that is transported to the third hydrocarbon processing facility to form a second hydrogen gas product wherein, on average, a mass flow rate of the first hydrogen gas portion is at least 90% of a combined mass flow rate of the hydrogen gas product at the second hydrocarbon processing facility and the second hydrogen gas product.

Aspect 4. The method of any one of aspects 2-3, wherein the hydrogenated hydrocarbon cut that is transported to the second hydrocarbon processing facility comprises saturated cyclic C9+ hydrocarbons.

Aspect 5. The method of any one of aspects 1-4, further comprising one or both of: producing the first hydrogen gas portion by the method with no direct carbon emissions; or producing the second hydrogen gas portion by the method with direct carbon emissions to the atmosphere.

Aspect 6. The method of any one of aspects 1-5, wherein transporting the portion of the hydrogenated effluent comprises moving the portion of the hydrogenated effluent by truck, train, or ship.

Aspect 7. The method of any one of aspects 1-6, wherein the portion of the hydrogenated effluent that is transported from the first hydrocarbon processing facility to the second hydrocarbon processing facility is a liquid at a temperature of 20° C. and a pressure of 1 atmosphere.

Aspect 8. The method of any one of aspects 1-7, wherein the hydrogenator is a hydrotreater.

Aspect 9. The method of aspect 8, wherein the hydrotreater is operated at a temperature of from 200° C. to 260° C. and a pressure of from 20 bar to 50 bar.

Aspect 10. The method of any one of aspects 1-7, wherein the hydrogenator is a hydrocracker.

Aspect 11. The method of aspect 10, wherein the hydrocracker is operated at a temperature of from 350° C. to 450° C. and a pressure of at least 30 bar.

Aspect 12. The method of any one of aspects 1-11, wherein the hydrocarbon feed comprises heavy naphtha, C9+ aromatic hydrocarbons, or both.

Aspect 13. The method of aspect 12, further comprising producing the hydrocarbon feed by combining heavy naphtha and C9+ aromatic hydrocarbons to form the hydrocarbon feed, wherein the heavy naphtha has an initial boiling point from 80° C. to 100° C. and a final boiling point from 180° C. to 200° C.

Aspect 14. The method of any one of aspects 1-13, further comprising transporting the separated-dehydrogenated effluent from the second hydrocarbon processing facility to the first hydrocarbon processing facility and introducing the separated-dehydrogenated effluent to the hydrogenator as part of the hydrocarbon feed.

Aspect 15. The method of any one of aspects 1-14, wherein the method to produce the first hydrogen gas portion comprises one or more of: utilization of renewable electricity; utilization of fossil fuels and sequestration of the produced carbon; or utilization of nuclear fission or fusion.

Aspect 16. The method of any one of aspects 1-15, wherein a ratio of the number of hydrogen atoms in the first hydrogen gas portion to the number of hydrogen atoms in the second hydrogen gas portion is from 9:1 to 1:9.

Aspect 17. The method of any one of aspects 1-16, wherein, on average, a mass flow rate of the first hydrogen gas portion is at least 101% of a mass flow rate of the hydrogen gas product.

Aspect 18. The method of any one of aspects 1-17, wherein, on average, a mass flow rate of the first hydrogen gas portion is from 90% to 115% of a mass flow rate of the hydrogen gas product.

Aspect 19. The method of any one of aspects 1-18, wherein, on average, a mass flow rate of the first hydrogen gas portion is from 100% to 115% of a mass flow rate of the hydrogen gas product.

Aspect 20. The method of any one of aspects 1-19, wherein: the hydrocarbon feed comprises C9+ aromatic compounds; and on average, a mass flow rate of the first hydrogen gas portion to the mass flow rate of the C9+ aromatic compounds in the hydrocarbon feed is from 1:14 to 1:10.

For the purposes of describing and defining the present disclosure it is noted that the terms “about” or “approximately” are utilized in this disclosure to represent the inherent degree of uncertainty that may be attributed to any quantitative comparison, value, measurement, or other representation. The terms “about” and/or “approximately” are also utilized in this disclosure to represent the degree by which a quantitative representation may vary from a stated reference without resulting in a change in the basic function of the subject matter at issue.

It is noted that one or more of the following claims utilize the term “wherein” as a transitional phrase. For the purposes of defining the present technology, it is noted that this term is introduced in the claims as an open-ended transitional phrase that is used to introduce a recitation of a series of characteristics of the structure and should be interpreted in like manner as the more commonly used open-ended preamble term “comprising.”

Any quantitative value expressed in the present application may be considered to include open-ended embodiments consistent with the transitional phrases “comprising” or “including” as well as closed or partially closed embodiments consistent with the transitional phrases “consisting of” and “consisting essentially of.”

It is also noted that recitations herein of “at least one” component, element, etc., should not be used to create an inference that the alternative use of the articles “a” or “an” should be limited to a single component, element, etc.

What is claimed is:

1. A method of transporting hydrogen, the method comprising:
providing hydrogen gas comprising a first hydrogen gas portion and a second hydrogen gas portion, wherein the first hydrogen gas portion is hydrogen produced by a method with no direct carbon emissions to the atmosphere and the second hydrogen gas portion is hydrogen produced by a method with direct carbon emissions to the atmosphere;
at a first hydrocarbon processing facility, hydrogenating a hydrocarbon feed in a hydrogenator, in the presence of the hydrogen gas comprising the first hydrogen gas portion and the second hydrogen gas portion, to form a hydrogenated effluent that comprises hydrogen atoms from the first hydrogen gas portion and the second hydrogen gas portion, wherein the hydrogenated effluent has a greater ratio of hydrogen to carbon than the hydrocarbon feed;
transporting a portion of the hydrogenated effluent from the first hydrocarbon processing facility to a second hydrocarbon processing facility, wherein the first hydrocarbon processing facility and the second hydrocarbon processing facility are separated by a distance of at least 100 km; and
at the second hydrocarbon processing facility, dehydrogenating the portion of the hydrogenated effluent to form a hydrogen gas product and a separated-dehydrogenated effluent;
wherein, on average, a mass flow rate of the first hydrogen gas portion is at least 90% of a mass flow rate of the hydrogen gas product.

2. The method of claim 1, further comprising, at the first hydrocarbon processing facility, separating the hydrogenated effluent into two or more hydrogenated hydrocarbon cuts, wherein the portion of the hydrogenated effluent that is transported to the second hydrocarbon processing facility comprises one of the two or more hydrogenated hydrocarbon cuts.

3. The method of claim 2, further comprising:
transporting at least one of the two or more hydrogenated hydrocarbon cuts to a third hydrocarbon processing facility; and
at the third hydrocarbon processing facility, dehydrogenating the at least one hydrogenated hydrocarbon cut that is transported to the third hydrocarbon processing facility to form a second hydrogen gas product wherein, on average, a mass flow rate of the first hydrogen gas portion is at least 90% of a combined mass flow rate of the hydrogen gas product at the second hydrocarbon processing facility and the second hydrogen gas product.

4. The method of claim 2, wherein the hydrogenated hydrocarbon cut that is transported to the second hydrocarbon processing facility comprises saturated cyclic C9+ hydrocarbons.

5. The method of claim 1, further comprising one or both of:
producing the first hydrogen gas portion by the method with no direct carbon emissions; or
producing the second hydrogen gas portion by the method with direct carbon emissions to the atmosphere.

6. The method of claim 1, wherein transporting the portion of the hydrogenated effluent comprises moving the portion of the hydrogenated effluent by truck, train, or ship.

7. The method of claim 1, wherein the portion of the hydrogenated effluent that is transported from the first hydrocarbon processing facility to the second hydrocarbon processing facility is a liquid at a temperature of 20° C. and a pressure of 1 atmosphere.

8. The method of claim 1, wherein the hydrogenator is a hydrotreater.

9. The method of claim 8, wherein the hydrotreater is operated at a temperature of from 200° C. to 260° C. and a pressure of from 20 bar to 50 bar.

10. The method of claim 1, wherein the hydrogenator is a hydrocracker.

11. The method of claim 10, wherein the hydrocracker is operated at a temperature of from 350° C. to 450° C. and a pressure of at least 30 bar.

12. The method of claim 1, wherein the hydrocarbon feed comprises heavy naphtha, C9+ aromatic hydrocarbons, or both.

13. The method of claim 12, further comprising producing the hydrocarbon feed by combining heavy naphtha and C9+ aromatic hydrocarbons to form the hydrocarbon feed, wherein the heavy naphtha has an initial boiling point from 80° C. to 100° C. and a final boiling point from 180° C. to 200° C.

14. The method of claim 1, further comprising transporting the separated-dehydrogenated effluent from the second hydrocarbon processing facility to the first hydrocarbon processing facility and introducing the separated-dehydrogenated effluent to the hydrogenator as part of the hydrocarbon feed.

15. The method of claim 1, wherein the method to produce the first hydrogen gas portion comprises one or more of:
utilization of renewable electricity;
utilization of fossil fuels and sequestration of the produced carbon; or
utilization of nuclear fission or fusion.

16. The method of claim 1, wherein a ratio of the number of hydrogen atoms in the first hydrogen gas portion to the number of hydrogen atoms in the second hydrogen gas portion is from 9:1 to 1:9.

17. The method of claim 1, wherein, on average, a mass flow rate of the first hydrogen gas portion is at least 101% of a mass flow rate of the hydrogen gas product.

18. The method of claim 1, wherein, on average, a mass flow rate of the first hydrogen gas portion is from 90% to 115% of a mass flow rate of the hydrogen gas product.

19. The method of claim 1, wherein, on average, a mass flow rate of the first hydrogen gas portion is from 100% to 115% of a mass flow rate of the hydrogen gas product.

20. The method of claim 1, wherein:
the hydrocarbon feed comprises C9+ aromatic compounds; and
on average, a mass flow rate of the first hydrogen gas portion to the mass flow rate of the C9+ aromatic compounds in the hydrocarbon feed is from 1:14 to 1:10.
